(19) United States
(12) Patent Application Publication
(10) Pub. No.: US 2006/0110110 A1
(43) Pub. Date: May 25, 2006

(54) Optical turn system for optoelectronic modules

(76) Inventors: Robert H. Yi, San Jose, CA (US); Brenton A. Baugh, Palo Alto, CA (US); Jim H. Williams, Walnut Creek, CA (US); Robert E. Wilson, Palo Alto, CA (US); Richard A. Ruh, Monte Sereno, CA (US)

Correspondence Address: AVAGO TECHNOLOGIES, LTD., P.O. BOX 1920, DENVER, CO, 80201-1920, US

(21) Appl. No.: 10/995,691

(22) Filed: Nov. 22, 2004

(51) Int. Cl. G02B 6/36; G02B 6/32; G02B 6/12

(52) U.S. Cl. 385/93; 385/14; 385/15; 385/31; 385/33; 385/88; 385/89; 385/92

(57) ABSTRACT

An optical subassembly (OSA) for an optoelectronic module uses an optical turn that permits mounting of the OSA on a circuit board of a primary module. A fabrication process for the OSA can achieve low complexity and high yield from the ability to fabricate the OSA separate from fabrication of the primary module. Fabrication of the OSA can include a burn-in test of an optoelectronic chip on a flex circuit that is small to reduce yield loss costs when the optoelectronic chip is defective. The OSA and the primary module can be mechanically attached and electrically connected using wire bonding techniques.

### BACKGROUND

Optoelectronic modules are commonly designed to present a relatively small area on an end of the module that receives optical fibers and on an opposite end that plugs into an electronic system. The small area allows arrangement of the optoelectronic modules into a closely spaced array for parallel handling of a large number of optical signals. However, such optoelectronic modules have a basic packaging problem in that chips containing the light sources such as Light Emitting Diodes (LEDs) and Vertical Cavity Surface Emitting Lasers (VCSELs) or the light detectors such as photodiodes and PIN detectors typically require light paths that are perpendicular to the top surface of the chip. The chip or chips containing the light sources and/or detectors can be oriented parallel to the end that receives the optical fibers, but the end area is generally too small to accommodate all of the optoelectronic devices, the integrated circuits (ICs), and other components required in the optoelectronic module.

One packaging solution for optoelectronic modules arranges an optoelectronic chip with a major surface parallel to the end face of the optoelectronic module and uses an electrical bend in a flex circuit to connect the optoelectronic chip to a perpendicular circuit board containing the remainder of the circuitry of the optoelectronic module. The perpendicular circuit board extends along the length of the optoelectronic module and does not interfere with the desired packing density of optoelectronic modules in arrays.

Another packaging concern for optoelectronic modules is the alignment of discrete optical elements with the light sources and/or detectors on optoelectronic chips. In particular, an optoelectronic module generally requires highly precise alignment between the light source (e.g., a laser or LED on the transmit side or a fiber on the receive side), an intervening lens element, and a target (e.g., a fiber for the transmit side or a photodiode for the receive side).

Yet another technical hurdle for packaging of optoelectronic modules is the thermal management of high power ICs such as microcontrollers, encoders, decoders, or drivers that are in the optoelectronic modules with temperature sensitive optoelectronic devices. Thermal management is particularly important because the performance of optoelectronic devices such as VCSELs can be extremely sensitive to temperature fluctuations. The optoelectronic devices are preferably isolated or otherwise protected from the heat produced by the high power ICs in an optoelectronic module.

FIG. 1 schematically illustrates a conventional optoelectronic module 100 using a flex circuit 110 to connect an optoelectronic chip 130 to a perpendicular circuit board 140 on which high power ICs 150 are mounted. A shared heat spreader 160 helps conduct heat generated in the high power ICs 150 and chip 130 to a heat sink 170, which generally has fins for heat dissipation. Flex circuit 110 provides electrical paths between optoelectronic chip 130 and perpendicular circuit board 140 or ICs 150, so that a light path perpendicular to the surface of optoelectronic chip 130 can be aligned with an optical fiber 190 and intervening optical elements 180.

ICs 150 are generally much less sensitive to heat than is optoelectronic chip 130. Accordingly, circuit board 140 can be selected to provide a low thermal conductivity to allow ICs 150 to self-heat. However, heat spreader 160 provides a thermal path between the high power ICs 150 and the temperature sensitive chip 130, so that the distance between circuit board 140 or ICs 150 and chip 130 needs to be relatively large to control heat flow from ICs 150 to optoelectronic chip 130. Increasing the distance generally increases the required size and cost of flex circuit 110.

A further concern for optoelectronic modules is manufacturing yield. A typical process for manufacturing optoelectronic module 100 attaches optoelectronic chip 130 to flex circuit 110, at which point the chip/flex circuit assembly is tested. However, attaching the assembly to heat spreader 160 and making connections to circuit board 140 requires further manipulation of the chip/flex circuit assembly. The additional manipulations increase the risk of damage that lowers manufacturing yield of operable optoelectronic modules.

Yield loss whether due to additional handling or other causes is a significant expense. For example, testing of an optical module typically requires a burn-in during which a VCSEL or other laser in optoelectronic chip 130 operates at power for long periods of time at temperature to weed out failures. A conventional fabrication process that requires attachment of flex circuit 110 for burn-in testing of chip 130 will suffer the expense of loss of flex circuit 110 if chip 130 fails. This is a significant additional expense since flex circuit 110 typically can be 50% of the optical sub-assembly cost, particularly when flex circuit 110 must be sufficiently large to provide an electronic bend as described above.

Optoelectronic modules are sought that can be manufactured with high yield and low manufacturing cost and that provide the desired module profile, the required optical alignment, and the required thermal management.

### SUMMARY

In accordance with an aspect of the invention, an optoelectronic module uses optical turning to direct light signals into or out of the optoelectronic module. With this optical turning, one or more optoelectronic chips can be mounted on a substrate such as a circuit board, a ceramic sub-mount, or a combination of a flex circuit and a supporting heat spreader. After testing of the optoelectronic chip on the substrate, an optional lens element, and a cap including an integrated turning mirror and an alignment feature can be attached to the substrate or the optoelectronic chip to complete an optical subassembly. A heat sink can also be attached to the substrate adjacent to the cap. Wire bonding can then electrically connect the optical subassembly to a primary module containing high power ICs. The optical subassembly and the primary module can have separate thermal paths to a shared heat sink to minimize thermal disturbances arising from the high power ICs.

A fabrication process for the optoelectronic modules can attach an optoelectronic chip to a substrate and test (e.g., burn-in) the resulting structure. The tested structure has a relatively low invested cost, which therefore provides a low loss cost for defective chips. In one specific embodiment, the substrate includes a flex circuit that is substantially smaller and simpler than flex circuits conventionally employed. Flex circuit costs being highly dependent on size and complexity can be reduced substantially, e.g., on the order of a factor of 10 reduction in cost for some embodiments of the invention. A cap that provides a hermetic seal for the optoelectronic chip can include a curved or planar turning mirror and an alignment post that can be fabricated as a one-piece structure from a low cost material such as plastic. Attaching the cap to the substrate completes an optical subassembly. The optical subassembly is a relatively resilient structure when compared to prior structures having large attached flex circuits and can reduce the chance of damage and improve the yield when assembling the optical subassembly into the optoelectronic module. A primary module containing a high power IC can be separately fabricated, before the primary module and the optical subassembly are attached to a heat sink and electrically interconnected, for example, by wire bonding.

One specific embodiment of the invention is an optoelectronic module that includes an optical subassembly, a primary module, and a heat sink, with the optical subassembly being mounted on the primary module and the heat sink being mounted on the optical subassembly. The optical subassembly includes a substrate that is substantially parallel to the primary module and an optical turn system that turns a light path of the optical subassembly between being perpendicular to the substrate to being parallel to the substrate. In addition, the optical subassembly may include an optoelectronic chip mounted on the substrate, and the optoelectronic chip may contain multiple devices such as light sources or detectors for parallel optics applications. A protective cap with a planar or curved turning mirror can enclose and protect the optoelectronic chip with electric traces extending outside the cap, and bond wires can electrically connect the optical subassembly and the primary module.

Another specific embodiment of the invention is a process for fabricating an optoelectronic module. The process generally includes fabricating an optical subassembly including an optical turn and attaching the optical subassembly to a primary module. A heat sink can be attached to the optical subassembly. When attached, a substrate in the optical subassembly is substantially parallel to the primary module. The optical subassembly and the primary module can be electrically connected, for example, using wire bonding.

### BRIEF DESCRIPTION OF THE DRAWINGS

FIG. 1 illustrates a conventional optoelectronic module using an electrical bend to position devices for optical signals.

FIG. 2 is a partial cutaway view of an optoelectronic module in accordance with an embodiment of the invention including a lens and a turning mirror.

FIG. 3 is a partial cutaway view of an optoelectronic module in accordance with an embodiment of the invention including a turning mirror that focuses a light signal.

FIG. 4 is a top view of an optoelectronic module in accordance with an embodiment of the invention having multiple optical channels.

FIG. 5 illustrates heat flow in an optoelectronic module in accordance with an embodiment of the invention.

FIG. 6 is a flow diagram of a fabrication process for an optoelectronic module in accordance with an embodiment of the invention.

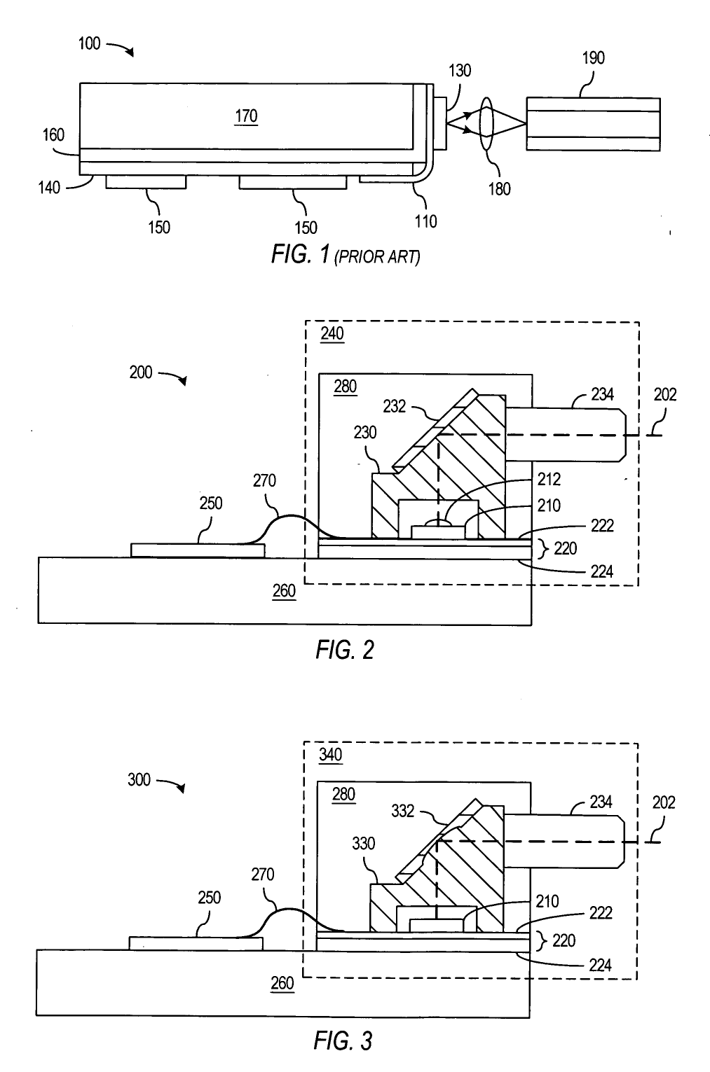

Use of the same reference symbols in different figures indicates similar or identical items.

### DETAILED DESCRIPTION

In accordance with an aspect of the invention, an optical subassembly (OSA) for an optoelectronic module uses an optical turn. A fabrication process for the optical subassembly can achieve low complexity and high yield from the ability to fabricate the optical subassembly separate from fabrication of the primary module containing high power integrated circuits. The optical subassembly can be attached to the primary module board and electrically connected using bond wires, without permitting undesirable heat flow. A heat sink can be attached to the optical subassembly to improve thermal properties of the optoelectronic module.

FIG. 2 illustrates an optoelectronic module 200 in accordance with an embodiment of the invention. Optoelectronic module 200 includes an optoelectronic chip 210, which includes one or more optoelectronic devices such as Light Emitting Diodes (LEDs), Vertical Cavity Surface Emitting Lasers (VCSELs), photodiodes, or PIN detectors. The following description concentrates on an exemplary embodiment of the invention where chip 210 contains an array of VCSELs that operate in parallel, but the structure and assembly of embodiments of the invention containing other types of light sources and/or light detectors will be apparent to those skilled in the art in view of the following description.

VCSELs have widespread use in optoelectronic modules because VCSELs are inexpensive to manufacture in high-density arrays that can be fabricated using standard IC fabrication methods. Additionally, VCSELs illustrate some of the basic packaging problems for optoelectronic modules. In particular, a light beam exits from a VCSEL perpendicular to a major surface of chip 210, but the end area of the optical module package is typically small, e.g., about 14 mm by 14 mm or smaller, to permit arrangement of optoelectronic modules in compact arrays. Additionally, the performance of a VCSEL is temperature sensitive requiring thermal management of high power ICs.

Chip 210 is mounted on a substrate 220. Substrate 220 serves as a base for an optical subassembly 240 and is electrically functional to provide electrical connections to bonding pads or other electrical contacts on chip 210. Substrate 220 also includes bonding pads that will be accessible upon completion of optical subassembly 240. In the embodiment shown, substrate 220 includes a flex circuit 222 attached to a heat spreader 224. Flex circuit 222 can be of conventional construction and includes conductive traces (not shown) that extend from the electrical locations corresponding to contacts on chip 210 to an accessible area of flex circuit 222. A typical flex circuit 222, for example, includes one or more layers conductive metal traces such as copper or aluminum about 25 to 50 microns thick that are insulated from each other by layers of a material such as polyimide about 25 to 100 microns thick. In a typical embodiment, flex circuit 222 is about 3 mm by 5 mm, which is significantly smaller than the flex circuit area required for a typical electrical bend. Heat spreader 224 can be made of a thermally conductive material such as aluminum about 0.2 to several mm thick and also serves as a stiffener for flex circuit 222. Alternative embodiments of substrate 220 include an organic printed circuit board or a silicon or ceramic sub-mount with suitable traces for electrical connections to chip 210 and external bonding.

A cap 230 attaches to substrate 220 and hermetically seals or otherwise protects chip 210 from the surrounding environment. A portion of cap 230 is cut away in FIG. 2 to better illustrate chip 210. Cap 230 includes integrated optical elements including a turning mirror 232 and alignment features 234. Turning mirror 232 can be oriented at 45° to light path 202 to provide a 90° optical turn. As a result, the surface of chip 210 in module 200 can be perpendicular to the end face that receives the optical fibers (not shown). Alignment features 234 are preferably structures such as posts or indentations that can engage an optical fiber assembly to automatically align the optical fiber assembly to the optoelectronic devices on chip 210.

In an exemplary embodiment of the invention, a molding process can form cap 230 including alignment features 234 and the optical surface of turning mirror 232 as parts of a one-piece structure made of a material such as polyetherimide (trade name ULTEM) or another optically clear plastic such as acrylic or polycarbonate. Ultimately, the material selection will depend on the application wavelength; for example, silicon may be used at a wavelength of 1310 nm where silicon is transparent. In alternative embodiments of the invention, turning mirror 232 either relies on total internal reflections or a reflective coating such as gold, silver, or copper in the area of turning mirror 232 to reflect optical signals.

In the embodiment of FIG. 2, lens elements 212 made of a material such as sapphire or high purity silica are on optoelectronic chip 210 over the respective apertures of the optoelectronic devices in chip 210. For a VCSEL or other light source in chip 210, the corresponding lens element 212 has a focal length designed such that the emerging light from the VCSEL after reflection from turning mirror 232 is collimated or focused for incidence on the core of a corresponding optical fiber. For a light detector in optoelectronic chip 210, lens elements 212 collect light and concentrate the light on light sensitive regions of the detectors. In an exemplary embodiment, lenses 212 are fabricated on optoelectronic chip 210 using techniques such as described in U.S. patent application Ser. No. 10/795,064, entitled “Large Tolerance Fiber Optic Transmitter And Receiver.”

FIG. 3 illustrates an optoelectronic module 300 including an optical subassembly 340 that uses an alternative optical system. In particular, optical subassembly 340 employs a cap 330 having a focusing mirror 332. With focusing mirror 332, lenses are not required on optoelectronic chip 210. For a light source in chip 210, focusing mirror 332 can turn and focus light from the light source, so that an emerging beam is incident on the core of a corresponding optical fiber. For a light detector in optoelectronic chip 210, focusing mirror 332 can collect light and concentrate the light on a light sensitive region of the detector. The cap 330 including focusing mirror 332 can be formed, for example, using plastic that is injection molded to produce the desired optical surfaces.

Attachment of cap 230 or 330 to substrate 220 can be conducted while monitoring the performance of the optoelectronic devices on chip 210. In particular, cap 230 or 330 can be aligned to optimize the locations of emerging light beams relative to alignment features 234 or the performance of detectors when input beams have the desired positions relative to alignment features 234. When the light paths have their desired positions relative to the alignment features 234, cap 230 or 330 can be fixed in place using an adhesive or other attachment technique. One cost effective attachment method uses an epoxy or epoxy system. For example, a Light-Cure Resin (LCR) can be used to tack cap 230 or 330 in position on substrate 220, and then with cap 230 or 330 in the proper position a structural adhesive can be added to provide strength and stability. An alternative method uses a dual cure adhesive that can be initially crosslinked by light, but then requires a thermal cure to achieve the adhesive's best material properties. Attachment of cap 230 or 330 to substrate 220 completes optical subassembly 240 or 340.

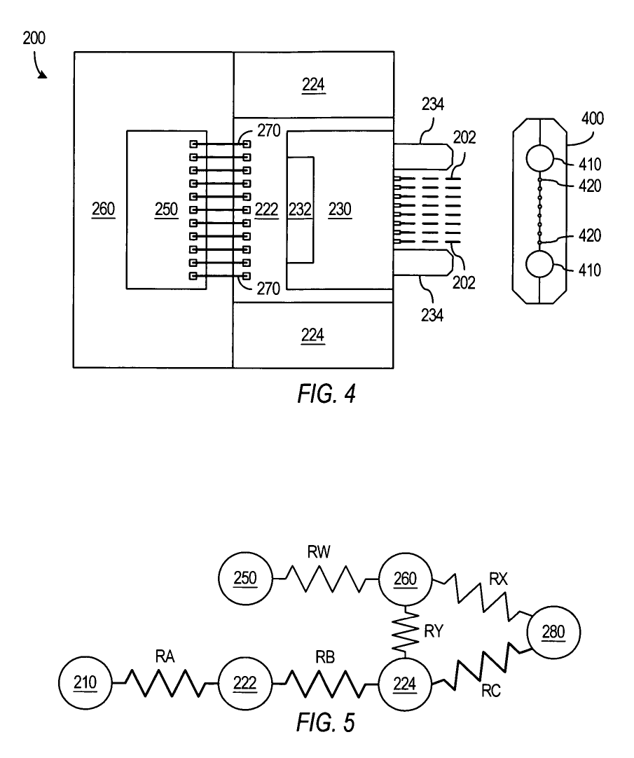

FIG. 4 shows a top view of optoelectronic module 200 and particularly illustrates the positions of light paths 202 relative to alignment features 234 in a parallel optics application. For the embodiment illustrated in FIG. 4, an optical fiber assembly 400 includes alignment features 410 (e.g., slots or holes) sized and positioned to engage corresponding alignment features 234 on cap 230. When alignment features 234 and 410 are engaged, optical fibers 420 in assembly 400 are aligned with light paths 202 associated with respective optoelectronic devices.

A manufacturing process conducted in parallel with fabrication of the optical subassembly can manufacture a primary module including circuit board 260 and the remainder of the active circuitry of optoelectronic module 200. Circuit board 260 generally contains one or more ICs 250 that function as the Electrical Sub-Assembly (ESA) that controls how the light is received or transmitted, translates optical signals into digital output, and communicates with a host board or server. ICs 250 generally incorporate an array of functions and depend on the application of the module, but the ICs 250 will typically include a controller, a driver IC for the laser and/or PIN, a preamplifier/postamplifier IC for the PIN, and an EEPROM to allow programming of the module. Such IC's are often custom and may include critical functions such as an A/D converter and temperature control sensor for the lasers. In an exemplary embodiment, circuit board 260 is a printed circuit board containing an organic insulating material such as polyimide, FR-4, or other PCB material and metal traces that may be connected to ICs 250 by bond wires or other electrical connections. Such circuit boards for optoelectronic modules are well known in the art and can be fabricated using many different structures and techniques.

Optical subassembly 240 is mounted on circuit board 260 and a heat sink 280 can be mounted on portions of substrate 220 in the optical subassembly. Heat sink is thus near the top of module 200 where air may flow through module 200. In particular, optical subassembly 240 and circuit board 260 may fit into a housing (not shown), and the housing may include the heatsink, but typically heat sink 280 is a separate part that clips or attaches to the housing and/or heat spreader 224. FIG. 4 shows exposed areas on opposite ends of heat spreader 224 where portions of heat sink 280 can directly contact heat spreader 224, while flex circuit 222 and cap 230 are between two exposed portions of heat spreader 224. Heat sink 280 can be made of a metal such as aluminum that is shaped to include fins or other structures that help dissipate heat that circuit board 260 and optical subassembly 240 generate.

Circuit board 260 is separated from but parallel to optical subassembly 240. Accordingly, a flex circuit is not required for electrical connection between optical subassembly 240 and circuit board 260. Instead, bond wires 270 electrically connect optical subassembly 240 to circuit board 260 or to ICs 250. A separation of about 25 to 100 microns is generally desired between optical subassembly 240 or 340 and contact pads on circuit board 260 to permit wire bonding that electrically connects optical subassembly 240 or 340 to circuit board 260 or to an integrated circuit 250 on circuit board 260. Short wire bond lengths are generally desirable to minimize impedance and electrical noise. Although wire bonding is well suited for the connections among subassembly 240, ICs 250 and board 260, other connection techniques could be used for some or all of the desired electrical connections. For example tab bonding can provide a direct electrical connection between flex circuit 222 and circuit board 260.

The use of a separate optical subassembly 240 permits a direct thermal path from optoelectronic chip 210 to heat sink 280 and a high resistance thermal path from ICs 250 to optoelectronic chip 210. FIG. 5 schematically illustrates heat flow paths in optoelectronic module 200. Thermal resistances RA, RB, are RC from chip 210 through flex circuit 222 and heat spreader 224 to heat sink 230 are low because flex circuit 222 is thin and heat spreader 224 spreads heat from optoelectronic chip 210 over a large area of heat sink 280. However, thermal resistances RW, RX, RY from ICs 250 through circuit board 260 to heat spreader 262 or heat spreader 280 are relatively high because must heat flow through adhesives and circuit board 260. Backflow to chip 210 can be made small by controlling the adhesive or bond material (e.g., the thermal resistance RX between heat sink 280 and circuit board 260. Accordingly, there are two nearly independent thermal dissipation paths. Thermal resistances RA, RB, and RC control the temperature of chip 210, and thermal resistances RW and RX control the temperature of ICs 250 on circuit board 260. This allows the chip 210 and ICs 250 to operate at distinct temperatures in the same ambient conditions.

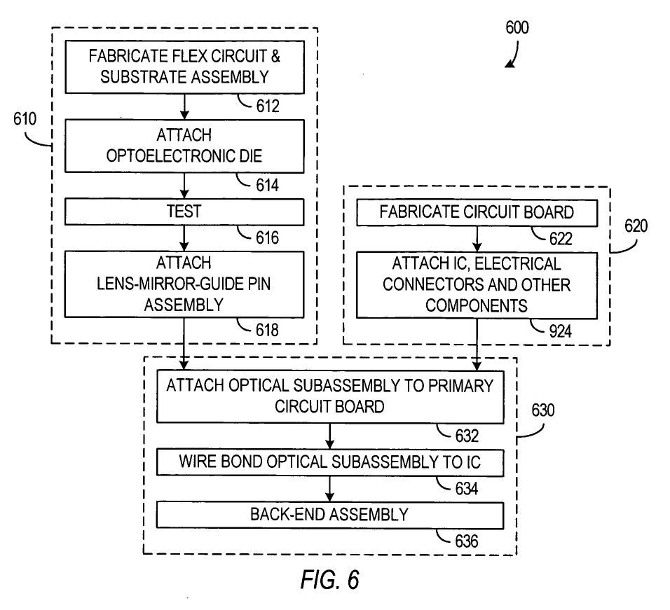

FIG. 6 illustrates an optical subassembly fabrication process 600 in accordance with an embodiment of the invention. Process 600 includes separate fabrication processes 610 and 620, which respectively produce an optical subassembly and a primary circuit board.

Fabrication of the optical subassembly begins with construction of a flex circuit/substrate assembly in step 612. The substrate, which acts as a stiffener and a heat spreader, can be made of an inexpensive conductor such as aluminum. The flex circuit is cut such that part of the substrate is exposed for direct contact to the heat sink, with the side benefit that minimizing the flex circuit area reduces the material cost. Step 614 is a die attach process that attaches and electrically connects (e.g., wire bonds) an optoelectronic chip to the flex/stiffener assembly. At this point, a lens assembly can be attached to the optoelectronic chip, for example, as shown in FIG. 2. Alternatively, no lens on the chip is required, for example, when the cap to be subsequently attached includes an ellipsoidal mirror to collimate and turn the light beam.

In step 616, the incomplete optical subassembly can undergo burn-in testing to screen out unreliable lasers or other devices on the chip. This testing can be very similar to the testing of the chip/flex circuit assembly in systems using an electrical bend, except that the flex circuit in embodiments of the current invention can be much smaller and therefore have a lower cost, providing a much lower yield loss cost. If test shows the chip is good, attachment step 618 aligns and attaches the cap to complete the optical subassembly.

Fabrication process 620 produces a primary module. The primary module includes a printed circuit board as described above that can be fabricated in step 622 using well known techniques. Step 624 then attaches integrated circuits, connectors, and other electronic components of the primary module.

Process 630 assembles the optical subassembly and the primary module. Process 630 of FIG. 6 attaches the optical subassembly to the primary module in step 632. A wire-bonding step 634 then electrically connects the optical subassembly to either the circuit board of the primary module or to specific chips in the primary module. The backend assembly 636 then completes the module. In particular, backend assembly 636 may include dropping the completed OSA/ESA combination into a housing, and then attaching of the heat sink to the housing (also making contact to the heat spreader in the optical subassembly).

In terms of overall flow of process 600, the fabrication process 610 of the optical subassembly can be conducted in parallel with the fabrication process 620 for a primary module. A defect arising in one component, i.e., the optical subassembly or the primary module only affects that component. In contrast, a conventional electrical bend solution commonly requires a linear fabrication process flow in which the most expensive components (e.g., the VCSEL and flex circuit) undergo the most handling. Damage or a defect arising during assembly of the primary module can require that a good optical subassembly be discarded, resulting an expensive cumulative yield loss during the conventional fabrication processes. In contrast, process 600 avoids the linear process flow and does not need extensive manipulation of flex circuits. The fabrication process can thus improve yield and reduce manufacturing costs.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. An optoelectronic module comprising:
a primary module; and
an optical subassembly mounted on the primary module, wherein the optical subassembly includes a substrate that is substantially parallel to the primary module and an optical turn system that turns a light path of the optical subassembly between being perpendicular to the substrate to being parallel to the substrate.

2. The module of claim 1, further comprising a heat sink directly contacting the substrate in the optical subassembly.

3. The module of claim 1, further comprising bond wires that electrically connect the optical subassembly and the primary module.

4. The module of claim 1, wherein the optical subassembly further comprises:
an optoelectronic chip mounted on the substrate; and
a cap that encloses the optoelectronic chip.

5. The module of claim 4, wherein the optical turn system comprises a turning mirror that is integrated as part of the cap.

6. The module of claim 5, wherein the turning mirror has a curved reflective surface.

7. The module of claim 5, further comprising a lens on the optoelectronic chip.

8. The module of claim 4, wherein the optoelectronic chip comprises a plurality of optoelectronic devices, each of which has a separate optical path, the optical turn system turning each of the separate optical paths between being perpendicular to the substrate to being parallel to the substrate.

9. The module of claim 8, wherein the optical turn system comprises a turning mirror that is integrated as part of the cap.

10. The module of claim 9, wherein the turning mirror has a curved reflective surface.

11. The module of claim 9, further comprising a plurality of lenses on the optoelectronic chip.

12. The module of claim 4, wherein the cap further comprises an alignment feature that marks a location of the optical path.

13. The module of claim 1, wherein the substrate in the optical subassembly comprises:
a stiffener; and
a flex circuit mounted on the stiffener.

14. A process for fabricating an optoelectronic module, comprising:
fabricating an optical subassembly including an optical turn;
fabricating a primary module;
attaching the optical subassembly to the primary module of the optoelectronic module, wherein a substrate in the optical subassembly is substantially parallel to the primary module; and
electrically connecting the optical subassembly to the primary module.

15. The process of claim 14, wherein fabricating the optical subassembly comprises:
attaching a flex circuit to a stiffener to form the substrate;
attaching and electrically connecting an optoelectronic chip to the flex circuit, the optoelectronic chip having a major surface parallel to the substrate; and
attaching a cap to protect the optoelectronic chip from a surrounding environment.

16. The process of claim 15, wherein the cap comprises a turning mirror that implements the optical turn.

17. The process of claim 15, further comprising testing the optoelectronic chip on the flex circuit before attaching the cap.

18. The process of claim 17, wherein testing of the optoelectronic chip comprises a burn-in test.

19. The process of claim 14, further comprising testing the optical subassembly before attaching the optical subassembly to the primary module.
